(19) United States
(12) Patent Application Publication
(10) Pub. No.: US 2013/0100204 A1
(43) Pub. Date: Apr. 25, 2013

(54) SYSTEMS FOR REGULATING AIRFLOW VELOCITY IN PRINT GAP REGIONS OF MICRO-FLUID EJECTION DEVICES

(71) Applicants: Sam Norasak, Lexington, KY (US); David C. Weatherly, Versailles, KY (US); Shirish Mulay, Lexington, KY (US); Eric S. Hall, Lexington, KY (US); Adam Neal Chalin, Lexington, KY (US)

(72) Inventors: Sam Norasak, Lexington, KY (US); David C. Weatherly, Versailles, KY (US); Shirish Mulay, Lexington, KY (US); Eric S. Hall, Lexington, KY (US); Adam Neal Chalin, Lexington, KY (US)

(21) Appl. No.: 13/276,624

(22) Filed: Oct. 19, 2011

(51) Int. Cl. B41J 23/00

(52) U.S. Cl. 347/37

(57) ABSTRACT

Disclosed is a system for regulating airflow velocity in a print gap region of a micro-fluid ejection device. The system includes a carrier member configured to carry an ejection head therewithin; a nozzle array configured at a bottom portion of the ejection head; and a channel member extending from a top portion of the carrier member and along a depth of the carrier member up to the bottom portion of the ejection head. Also, the channel member extends along at least a width of the nozzle array. Additionally, the channel member is configured to receive a flow of air through a slot configured at the top portion of the carrier member and to direct the flow of air from the top portion of the carrier member towards the bottom portion of the ejection head. Further disclosed is another system for regulating airflow velocity in a print gap region.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to micro-fluid ejection devices, such as printers, and more particularly, to systems for regulating/modifying airflow velocity in a print gap region of a micro-fluid ejection device.

2. Description of the Related Art

In a typical micro-fluid ejection device, fluid is ejected from an ejection zone (e.g., nozzle array/plate) of an ejection head (i.e., printhead) on to a print medium in a pattern corresponding to pixels of an image being printed. Over time and with the demand for higher resolution, the ejection head and fluid drops have become increasingly smaller.

However, while developing ejection heads for smaller fluid drop sizes, a “tree vein” or “wood grain” print defect has been observed on print media. Primarily, such a defect is characteristic of dark-toned bands meandering from outer edges of a print swath toward a center portion of the print swath (i.e., diagonal meandering) as a carrier of the ejection head moves across a print medium. The dark-toned bands are typically present along most of the print swath length except for a short portion near the beginning of fluid ejection/jetting. The dark-toned bands have been also observed across any print swath width for the fluid jetting nozzles that are spaced relatively closely together. The pattern of the dark-toned bands develops within a short distance of the print swath start and repeats with a spacing that varies with the ejection head and the micro-fluid ejection device. Further, the dark-toned bands appear to be caused by the concentration of small/satellites drops into organized bands. In effect the print gap airflow gathers the small/satellites drops together as the small/satellites drops move toward the print medium. The responsible time-dependent flow pattern is caused by interaction between the drop wakes and the oncoming print gap airflow.

While reduction of the print gap region from the ejection zone of the ejection head to the print medium tends to either minimize or eliminate the aforementioned defect, there is a lower practical limit to decreasing the print gap region. Specifically, very small to print gap region would inadvertently facilitate the print medium to lie in contact with the ejection head, thereby resulting in smearing of the yet-to-dry fluid.

In the print gap region, air velocity varies approximately linearly between the scan speed at the ejection zone of the ejection head and zero at the print medium. The wakes of the fluid drops effectively constitute a moving barrier that pushes out air as the ejection head scans. The result is a flow field in which the fluid velocity downstream meanders from side to side in irregularly shifting patterns. It is believed that main drops from the ejection head tend to travel to the print medium with little deviation due to large mass thereof. The smaller/satellite drops, on the other hand, are believed to slow down and become influenced in the direction by the local airflow. The observed wood grain print defect is consistent with the hypothesis, i.e., the small/satellite drops are channeled together into concentrated bands by the print gap airflow as modified by the wakes of the main drops.

It has also been observed that the flow field around the ejection head develops in both time and space. Such an effect also occurs in the print gap region, i.e., the airflow velocity profile changes with time and varies across the width of the ejection zone even when no fluid is being ejected/jetted. The time-dependence of the no-jetting flow field likely contributes to the wood grain print defect by forcing and enhancing local velocity oscillations around the ejection zone.

Another problem that is often encountered when the fluid drop sizes are decreased is referred to as misting. The low momentum carried by very small/satellite drops is easily overwhelmed by drag forces. Further, there is a tendency for the smallest satellites to come to a near-stop before reaching the print medium and then to be carried out of the print gap region by air currents. Such small/satellites drops deposit onto surfaces within the micro-fluid ejection device, thereby resulting in corrosion of electrical connections, obscuring encoder markings, and forming foul surfaces that a user might touch during replacement of either the ejection head or the fluid supply tank of the micro-fluid ejection device.

Various simulations of a conventional ejection head and a carrier member carrying the ejection head have been conducted to demonstrate the above described origin of wood grain print defect and misting of fluid drops. FIG. 1 depicts a schematic view of a prior art carrier member 100 for a micro-fluid ejection device, such as an inkjet printer (not shown). The carrier member 100 is depicted as a stationary block within a flow tunnel (not numbered) and includes a conventional ejection head (not shown). The flow tunnel includes a floor representing a surface of a print medium ‘P’ that moves past the ejection head at a typical speed of the carrier member 100. Further, an outboard side wall (not numbered) and a top wall (not numbered) of the flow tunnel that represent the interior surfaces of the micro-fluid ejection device, also move at the typical speed of the carrier member 100. Furthermore, an inboard side wall (not numbered) of the flow tunnel that includes a center plane of the ejection head is treated as a symmetry boundary. The velocity of air at the upstream/inflow plane (as depicted by ‘I’) is specified at the same typical speed as that of the carrier member 100. Also, the downstream plane is treated as an outflow plane (as depicted by ‘O’) with a specified stagnation pressure.

FIGS. 2-5 depict the gross flow field around the carrier member 100 within the flow tunnel. In FIGS. 2-5, the airflow direction is depicted by ‘A’ and the direction of the movement of the ejection head is depicted by ‘B’. For the purpose of this description, the ejection head (and the carrier member 100) may move/scan, but is not limited to, a speed of about 30 inches per second (IPS). A perspective view of the carrier member 100 having an ejection head 110 is depicted in FIG. 6 for the purpose of clarity.

The airflow in the print gap region defined between the ejection head 110 and the print medium boundary (not numbered) develops a velocity profile as depicted in FIG. 7. Specifically, FIG. 7 illustrates a schematic cross-sectional view of airflow field around the carrier member 100. As observed, the velocity profile is not monotonic, i.e., the air velocity at some locations in the print gap region is actually higher than the specified velocity at the print medium boundary. Further, the ejection head 110 occludes a significant fraction of the cross-sectional flow area. Since the inflow boundary velocity is fixed, conservation of mass requires that the flow speed up adjacent to the ejection head 110. Vector plots show that the airflow enters the print gap region at the upstream edge and immediately begins to diverge outward from the center plane of the ejection head 110, as depicted in FIG. 5.

A further simulation featuring interaction between fluid drops (moving particles) and the aforementioned airflow field demonstrates the effect of jetting many fluid drops from the ejection head 110 onto the print medium boundary. Specifically, two sets of fluid drops (hereinafter interchangeably referred to as “particles”) are ejected/released from the ejection zone configured underside of the ejection head 110 along a line (not numbered) transverse to the center plane of the ejection head 110 into the print gap region to (computational domain). The transverse line from which the particles originate represents an array of inkjet ejector nozzles (hereinafter referred to as “nozzle array”). The two sets of particles are specified to have diameters, densities, and initial velocities typical of inkjet main and satellite drops, respectively. As depicted, large particles/main drops (having large diameter, such as a diameter of about 20 micrometers) that settle in a line under the nozzle array are represented as a plurality of particles 120; and small particles/satellite drops (having small diameter, such as a diameter of about 6 micrometers) that are carried downstream are represented as a plurality of particles 130.

It will be evident that particles of both types are generated at rates typical of high-density inkjet printing at the specified speed of the carrier member 100. The particles 120 and 130 drag air in respective wakes down toward the print medium boundary. The presence of the print medium boundary causes the air in the particle wakes to rebound ahead of and behind the nozzle array in recirculation zones as depicted in FIG. 8.

Specifically, FIG. 8 depicts a schematic view to depict an interaction of drop wakes and oncoming airflow (stream) in the print gap region, such as a print gap region ‘G’, of the carrier member 100. Further, the ejection/jetting zone is depicted by ‘J’, direction of main airflow is depicted by ‘M’, direction of flow induced by particles (jetting drops) is depicted by ‘F’, and the print medium is depicted by ‘P’. Further, vectors as depicted in FIG. 8 show velocity relative to the ejection head 110. It is observed that recirculation zones (constituted by flow ‘F’) develop shortly after the particles 120 and 130 are released into the computational domain. For the purpose of this description, the particles 120 and 130 may be generated at a frequency of about 18 Kilo Hertz (kHz). The stream-wise location of the recirculation zones is determined by the locations where the particles are released. In the case of an ejection head with multiple parallel rows of ejector nozzles, the recirculation zone location may shift slightly either upstream or downstream according to the manner in which nozzle arrays are jetting. It is to be noted that the spacing of typical nozzle arrays is smaller than the stream-wise extent of the recirculation zones.

FIGS. 9-11 depict graphs 1000, 2000, and 3000, respectively, depicting schematic views for velocity vectors showing the airflow field in a horizontal plane located under the ejection head 110 and above the print medium boundary at several successive instants during the time-dependent simulation under different simulation conditions. Specifically, FIGS. 9-11 depict the particles 120 and 130; and velocity vectors close to the to ground plane of the carrier member 100. As depicted, the particles 130 are carried downstream and the particles 120 settle in a line under the nozzle array.

The in-flow boundary (not shown) provides airflow in a direction, such as the direction ‘M’ in FIGS. 9-11. Further, recirculation zones appear as areas of flow to the upstream direction and the downstream direction to the airflow. Furthermore, FIGS. 9-11 also depict locations where the particles 120 and 130 pass through the plane while traveling towards the print medium boundary after respective release/ejection from the ejection head 110. The particles 120 are observed to pass through a narrow line parallel to the nozzle array line from which the particles 120 are released. Due to the significant momentum of the particles 120, respective velocities thereof are slightly affected by aerodynamic drag forces. Accordingly, respective paths of the particles 120 are less affected by the airflow field through which the particles 120 pass. As a result, the particles 120 tend to deposit onto the print medium close to the intended locations thereof. However, the particles 130 are observed to pass through a wider band downstream of the nozzle array line. Further, due to lesser momentum, the particles 130 slow significantly because of the aerodynamic drag forces. Accordingly, the respective paths of the particles 130 are strongly affected by the airflow field through which the particles 130 pass. As a result, the particles 130 tend to deposit onto the print medium at various distances from the intended locations thereof.

FIGS. 9-11 also demonstrate a time-dependent interaction between the main airflow field established by the in-flow boundary condition and the recirculation flows induced by the particle wakes in the print gap region under the ejection head 110. Some of the in-flow boundary air approaching (in the direction ‘M’) is deflected around the jetting region/ejection zone as the air encounters the wakes of the particles (such as the particles 120 and 130). The remaining air passes through the jetting region where the air interacts with particle wakes to produce an unsteady flow that appears locally convergent and divergent depending on the time and the span-wise location along the particle release line. The convergent and divergent (unsteady) regions (respective ‘C’ and ‘D’ encircled portions) disproportionately influence the particles 130 that have little momentum and thus tend to follow the flow. Based on FIGS. 9-11, it may be seen that the particles 130 tend to cluster into irregular patches downstream of the jetting zone in a pattern typical of the wood grain print defect.

Further, the particles 130 tend to have a considerably slow movement due to drag as the particles 130 approach the print medium boundary. In the simulation, most of the particles 130 reach the print medium boundary and adhere thereto. However a fraction of the particles 130 tend to slow down as such particles approach the print medium boundary. Further, such particles are carried away from print medium boundary by the recirculation flows downstream out of the print gap region by the streaming flow as depicted in graphs 4000 and 5000 of FIGS. 12 and 13, respectively. Specifically, FIGS. 12 and 13 depict graphs 4000 and 5000, respectively, illustrating the particles 120 and 130, and velocity vectors in the print gap region cross-sectional area of the carrier member 100, under different simulation conditions. Trajectories of the particles 130 that escape from the print gap region are determined based on the gross flow field downstream of the ejection head 110.

FIG. 14 depicts a schematic view of velocity vectors in a cross-section of flow field around the carrier member 100 based on the above description. Further, FIG. 15 depicts a schematic view of velocity vectors at mid-gap height in flow field around the carrier member 100. It will be evident that the velocity vectors are depicted as arrows in FIGS. 1-5, and FIGS. 7-15 for the purpose of simplicity.

Based on the aforementioned, it will be evident that aerodynamic effects in the print gap region play a vital role when fluid drop sizes decrease in the drive to achieve higher print resolution.

Accordingly, there exists a need to regulate the airflow velocity in a print gap region of a micro-fluid ejection device in order to either minimize or eliminate various printing defects, and specifically when utilizing small volume drops of fluids.

### SUMMARY OF THE DISCLOSURE

In view of the foregoing disadvantages inherent in the prior art, the general purpose of the present disclosure is to provide systems for regulating airflow velocity in print gap regions of micro-fluid ejection devices, by including all the advantages of the prior art, and overcoming the drawbacks inherent therein.

The present disclosure provides a system for regulating airflow velocity in a print gap region of a micro-fluid ejection device. The system includes a carrier member configured to carry an ejection head therewithin. The carrier member is configured adjacent to a print medium to define the print gap region therebetween. Further, the system includes a nozzle array configured at a bottom portion of the ejection head. The nozzle array is to configured to eject a plurality of drops therefrom on the print medium for printing. Furthermore, the system includes a channel member extending from a top portion of the carrier member and along a depth of the carrier member up to the bottom portion of the ejection head. The channel member further extends along at least a width of the nozzle array. Also, the channel member is configured to receive a flow of air through a slot configured at the top portion of the carrier member. Moreover, the channel member is configured to direct the flow of air from the top portion of the carrier member towards the bottom portion of the ejection head and into the print gap region for creating a stagnation zone under the nozzle array. The stagnation zone extends up to a depth of the print gap region to regulate the airflow velocity in the print gap region.

Additionally, the present disclosure provides a system for regulating airflow velocity in a print gap region of a micro-fluid ejection device. The system includes a carrier member configured to carry an ejection head therewithin. The carrier member is configured adjacent to a print medium to define the print gap region therebetween. Further, the system includes a nozzle array configured at a bottom portion of the ejection head. The nozzle array is configured to eject a plurality of drops therefrom on the print medium for printing. Furthermore, the system includes a pair of channel members. The pair of channel members includes a first channel member extending along a leading edge of the carrier member and a second channel member extending along a trailing edge of the carrier member. Each of the first channel member and the second channel member further extends from a top portion of the carrier member up to a bottom portion of the carrier member and along a depth of the carrier member. The each of the first channel member and the second channel member is configured to direct a flow of air from the top portion of the carrier member towards the bottom portion of the carrier member and into the print gap region for forming an air curtain within the print gap region to regulate the airflow velocity in the print gap region.

### BRIEF DESCRIPTION OF THE DRAWINGS

The above-mentioned and other features and advantages of the present disclosure, and the manner of attaining them, will become more apparent and will be better understood by reference to the following description of embodiments of the disclosure taken in conjunction with the accompanying drawings, wherein:

FIG. 1 depicts a schematic view of a prior art carrier member for a micro-fluid ejection device;

FIGS. 2-5 depict the gross flow field around the carrier member of FIG. 1;

FIG. 6 depicts a perspective view of the carrier member of FIG. 1;

FIG. 7 depicts a schematic cross-sectional view of airflow field around the carrier member of FIG. 1;

FIG. 8 depicts a schematic view to depict an interaction of drop wakes and oncoming airflow (stream) in the print gap region for the carrier member of FIG. 1;

FIGS. 9-11 depict graphs illustrating schematic views for velocity vectors showing the airflow field in a horizontal plane located under an ejection head of the carrier member of FIG. 1 and above a print medium boundary at several successive instants during a time-dependent simulation;

FIGS. 12 and 13 depict graphs illustrating velocity vectors in a print gap region cross-sectional area of the carrier member of FIG. 1, under different simulation conditions;

FIG. 14 depicts a schematic view of velocity vectors in a cross-section of flow field around the carrier member of FIG. 1;

FIG. 15 depicts a schematic view of velocity vectors at mid-gap height in flow field around the carrier member of FIG. 1;

FIG. 16 depicts a perspective view of a system, in accordance with an embodiment of the present disclosure;

FIG. 17 depicts a steady state vortex with an ejection head of a carrier member of the system of FIG. 16 moving at a first predetermined speed;

FIG. 18 depicts a steady state vortex with the ejection head of the carrier member of the system of FIG. 16 moving at second predetermined speed;

FIG. 19 depicts a graph illustrating a representation of simulation of the airflow at a fixed location as a leading edge of the ejection head of the system of FIG. 16 approaches and passes overhead;

FIG. 20 depicts a representation of blowing a flow of air that enters into the print gap region with an upstream velocity component designed to produce a stagnation zone under a nozzle array of the system of FIG. 16;

FIG. 21 depicts a graph illustrating velocity vectors in proximity to ground plane in the print gap region within the system of FIG. 16;

FIG. 22 depicts a front elevated view of a system, in accordance with another embodiment of the present disclosure;

FIG. 23 depicts a top view of the system of FIG. 22;

FIG. 24 depicts a partial left elevated view of the system of FIG. 22;

FIG. 25 depicts a partial right elevated view of the system of FIG. 22;

FIG. 26 depicts a representation of velocity vectors in a cross-section of airflow field around a carrier member of the system of FIG. 22;

FIG. 27 depicts a plan view illustrating the airflow field around the carrier member of the system of FIG. 22, in a horizontal cross-sectional portion located at the middle of a print gap region;

FIG. 28 depicts print samples at 9 Kilo Hertz (kHz) produced by an ejection head of the system of FIG. 22;

FIG. 29 depicts print samples at 9 kHz without any implementation of blowing scheme of the system of FIG. 22;

FIG. 30 depicts print samples at 18 kHz produced by an ejection head of the system of FIG. 22; and

FIG. 31 depicts print samples at 18 kHz without any implementation of blowing scheme of the system of FIG. 22.

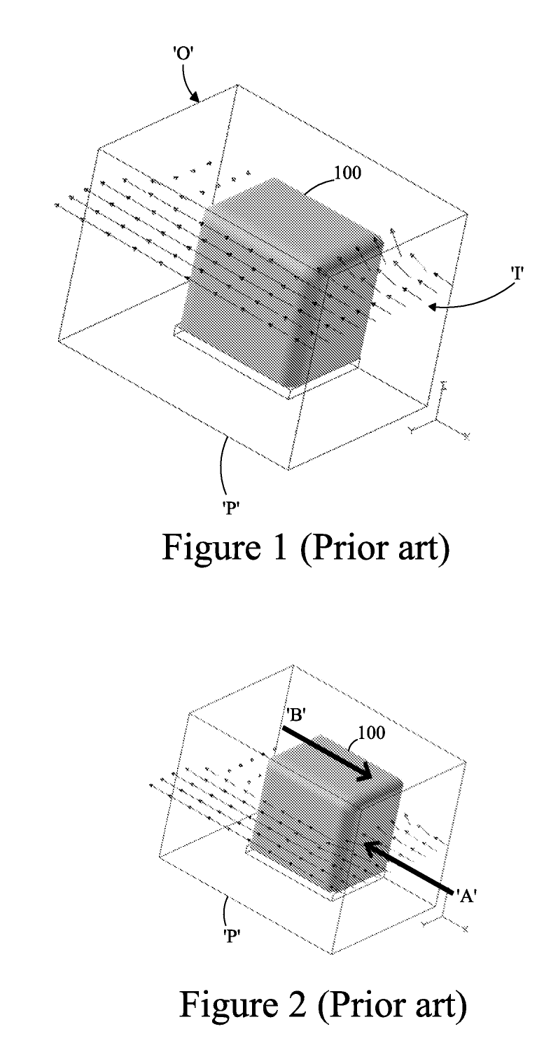

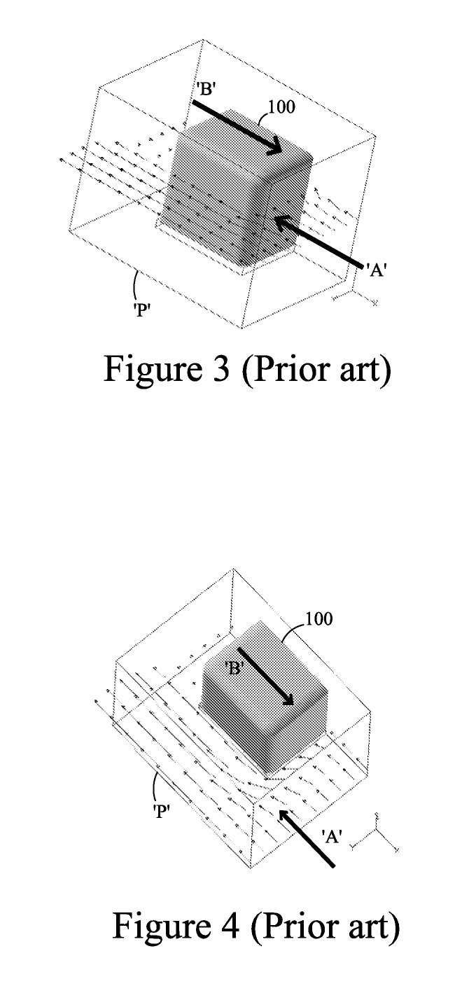

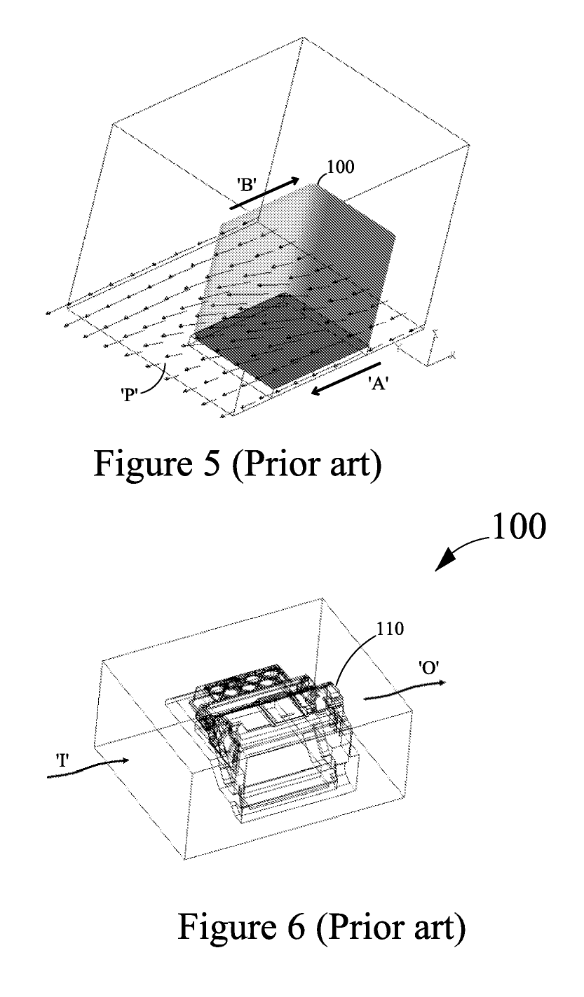

### DETAILED DESCRIPTION

It is to be understood that various omissions and substitutions of equivalents are contemplated as circumstances may suggest or render expedient, but these are intended to cover the application or implementation without departing from the spirit or scope of the claims of the present disclosure. It is to be understood that the present disclosure is not limited in its application to the details of components set forth in the following description. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the terms “a” and “an” herein do not denote a limitation of quantity, but rather denote the presence of at least one of the referenced item.

In one aspect, the present disclosure provides a system for regulating/modifying airflow velocity in a print gap region of a micro-fluid ejection device, such as a printer, and more specifically, an inkjet printer. The system of the present disclosure is described in conjunction with FIGS. 16-21.

FIG. 16 depicts a system 200, in accordance with an embodiment of the present disclosure. The system 200 includes a carrier member 210 configured to carry an ejection head 220 therewithin. The carrier member 210 is configured adjacent to a print medium 10 (such as a paper) to define a print gap region 20 therebetween.

The system 200 further includes a nozzle array 230 configured at a bottom portion 222 of the ejection head 220. The nozzle array 230 is configured to eject a plurality of drops therefrom on the print medium 10 for printing.

The system 200 further includes a channel member 240 extending from a top portion 212 of the carrier member 210 and along a depth ‘D1’ of the carrier member 210 up to the bottom portion 222 of the ejection head 220. The channel member 240 further extends along at least a width of the nozzle array 230. It will be evident that the channel member 240 may extend longer than the nozzle array 230 to avoid edge effects. Additionally, the channel member 240 is configured orthogonal to the print medium 10.

The channel member 240 is also configured to receive a flow of air ‘BF’ through a slot 242 configured at the top portion 212 of the carrier member 210. The channel member 240 is further configured to direct the flow of air ‘BF’ from the top portion 212 of the carrier member 210 towards the bottom portion 222 of the ejection head 220 and into the print gap region 20 for creating a stagnation zone under the nozzle array 230. The stagnation zone extends up to a depth of the print gap region 20 to regulate the airflow velocity in the print gap region 20.

Further, the channel member 240 directs the flow of air from the top portion 212 of the carrier member 210 towards the bottom portion 222 of the ejection head 220 and into the print gap region 20 in synchronization with ejection of the plurality of drops from the nozzle array 230 in order to regulate the airflow velocity in the print gap region 20. Furthermore, the channel member 240 directs the flow of air from the top portion 212 relative to the movement of the ejection head 220 and the print medium 10. Additionally, the flow of air is directed at a pre-determined angle relative to a horizontal plane (not shown) parallel to the nozzle array 230 for creating the stagnation zone. The pre-determined angle ranges from about 25 degrees to about 80 degrees relative to the horizontal plane, as depicted in FIG. 16. Moreover, the flow of air is directed at a pre-determined velocity. The pre-determined velocity of the directed flow of air ranges from about one third in magnitude of velocity of the ejection head 220 to about four times in magnitude of the velocity of the ejection head 220. However, it will be evident that the pre-determined angle and the pre-determined velocity need to be optimized for a given ejection head geometry, scanning speed, and print gap region.

Also, the channel member 240 directs the flow of air from the top portion 212 of the carrier member 210 towards the bottom portion 222 of the ejection head 220 and into the print gap region 20 from behind the nozzle array 230, as depicted in FIG. 16.

Without departing from the scope of the present disclosure, the flow of air is blown into the channel member 240 by a means, such as an air propelling member. Suitable example of an air propelling member includes, but is not limited to, a fan.

As depicted in FIG. 16, the direction of the normal airflow in the print gap region 20 is depicted by ‘AF’, and direction of the movement of the ejection head 220 is depicted by ‘B1’. Accordingly and as shown in FIG. 16, the system 200 is employed to regulate/modify the velocity (velocity profile) of the airflow (depicted by ‘AF’).

Based on the foregoing, the system 200 assists in mitigating problems associated with wood grain print defect and misting. Specifically, the system 200 assists in reducing the velocity of airflow in the print gap region 20 relative to the nozzle array 230 so that the plurality of drops encounter minimal stream-wise drag forces. More specifically, the system 200 assists in reducing the velocity of airflow in the print gap region 20 by facilitating blowing of air into the print gap region 20 behind the nozzle array 230.

Further, it is to be understood that the geometry of the carrier member 210 and the ejection head 220 strongly influences the airflow in the print gap region 20. Specifically, the carrier member 210 presents a design to minimize the resulting non-uniformity experienced by the plurality of drops being ejected from a plurality of nozzles (not shown) in the nozzle array 230. More specifically, the system 200 is configured to have the nozzle array 230 being configured adjacent to a portion (not numbered) of the print gap region 20 that defines a zone of uniform gradient of velocity of the airflow. The uniform gradient of velocity is experienced by the plurality of drops being ejected by the nozzle array 230.

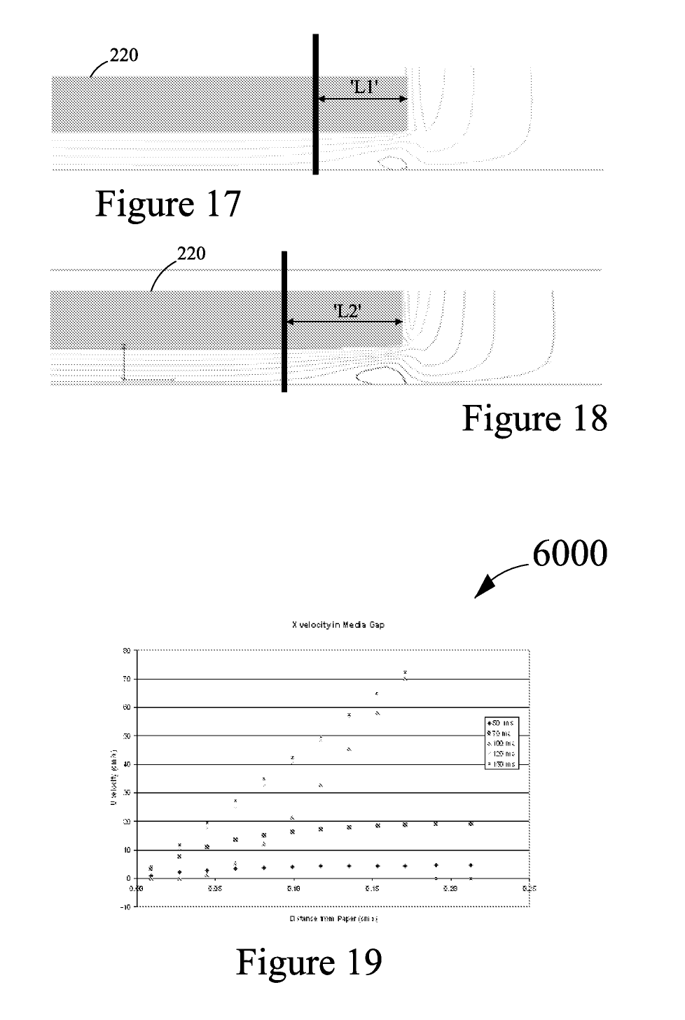

The movement/motion of the ejection head 220 generates a leading edge vortex that has a strength defined as a function of the scanning speed of the ejection head 220, geometry of the ejection head 220, and the print gap region 20. The leading edge vortex develops instantaneously at a leading edge (not shown) of the ejection head 220 at the start of the motion of the ejection head 220. The steady state vortex is illustrated in FIGS. 17 and 18. FIG. 17 depicts a steady state vortex with the ejection head 220 moving at a first predetermined speed, such as a speed of about 20 inches per second (IPS) at a specific settling length (depicted as ‘L1’), and FIG. 18 depicts a steady state vortex with the ejection head 220 moving at a second predetermined speed, such as a speed of about 30 IPS at a specific settling length (depicted as ‘L2’) larger than the specific settling length ‘L1’. The term, “settling length” may refer to as length of a portion/zone (not numbered) of the print gap region 20 that is influenced by the leading edge vortex.

FIG. 19 depicts a graph 6000 illustrating a representation of simulation of the airflow at a fixed location as the leading edge of the ejection head 220 approaches and passes overhead. Specifically, the graph 6000 depicts the scan/print direction airflow velocity magnitude being plotted within the print gap region 20 as a function of distance from to the print medium 10 at several stages during the scanning/printing process. As depicted in FIG. 19, the airflow velocity is characteristic of a concave down profile when the vortex is passing overhead. However, the airflow velocity profile changes to a concave upward profile as the vortex passes. As the influence of the passing vortex decreases, the airflow velocity profile in the print gap region 20 approaches the Couette flow profile. Further, drops ejected into the print gap region 20 at locations with such a steady airflow velocity profile are subject to relatively uniform aerodynamic forces regardless of the origin thereof along the nozzle array 230. The print gap region 20 that is influenced by the leading edge vortex is known as the settling zone as explained in conjunction with FIGS. 17 and 18. Further, drops ejected downstream of the settling zone are only minimally influenced by either the leading edge vortex or the stream-wise variation in the airflow velocity in the print gap region 20. The nozzle array 230 thus is located downstream of the settling zone. Such a configuration of the system 200 wherein the nozzle array 230 is located downstream of the settling zone facilitates the drops to experience the same gradient (i.e., uniform gradient) of airflow velocity in the print gap region 20 (i.e., print zone).

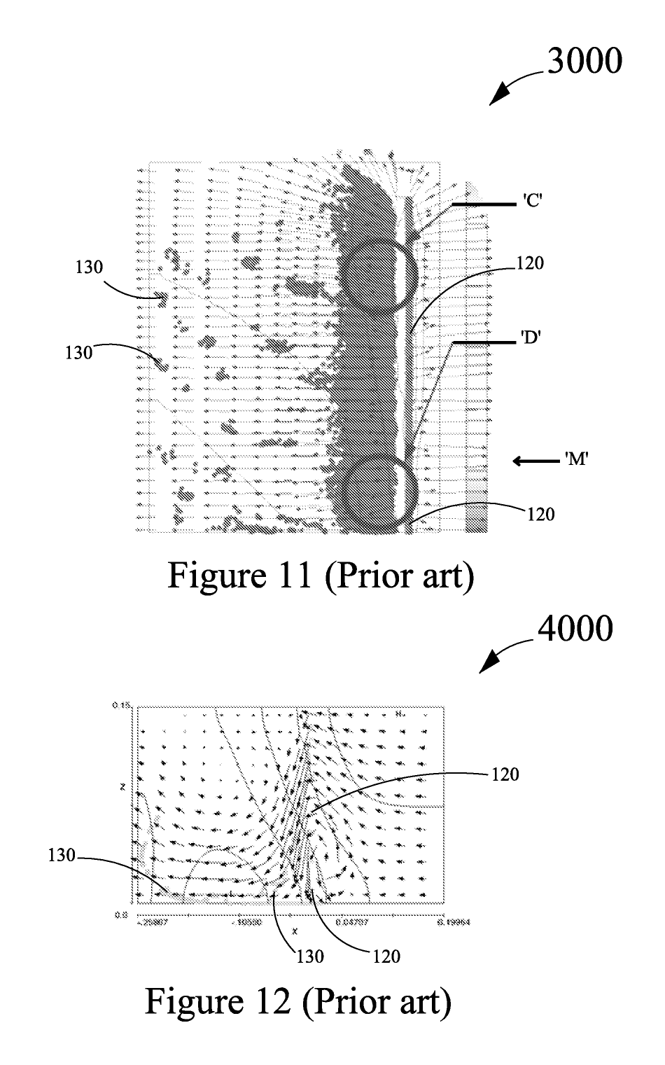

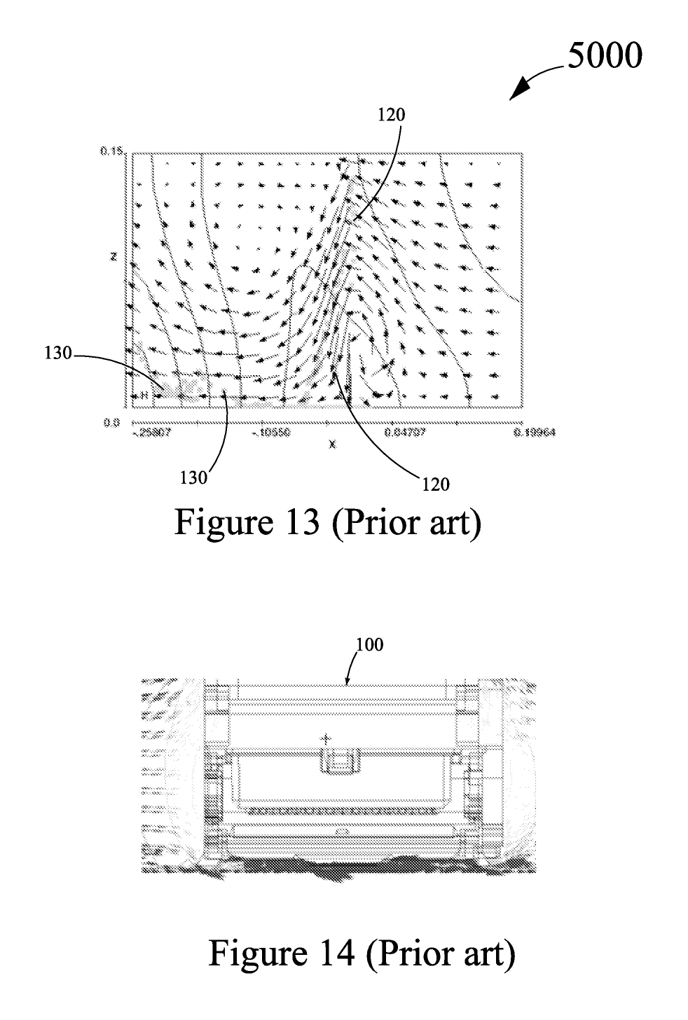

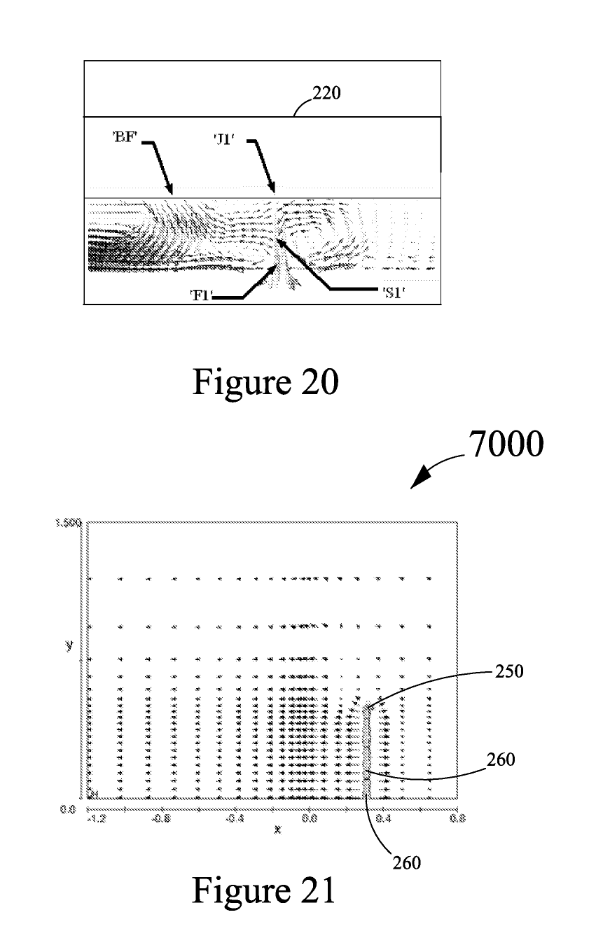

The system 200 accordingly establishes a stagnation zone (relative to the ejection head 220) at the stream-wise location of the nozzle array 230 across as much of the depth of the print gap region 20 as possible. The blowing solution provided by the system 200 was simulated in a manner similar to the generic ejection head 110. The flow field that results from blowing without particle ejection is shown to have a pattern as depicted in FIG. 20. The blowing simulation was repeated with large and small particle ejection as described in conjunction with prior art FIGS. 8-11. Specifically, FIG. 20 depicts a representation of velocity vectors in a cross-section view of the flow field of the print gap region 20 with blowing of air from behind the nozzle array 230. More specifically, FIG. 20 depicts a representation of blowing a flow of air that enters into the print gap region 20 with an upstream velocity component designed to produce a stagnation zone under the nozzle array 230. The flow of air blown by the channel member 240 is depicted by the symbol ‘BF’; the flow induced by ejecting/jetting of drops is depicted by the symbol ‘F1’; ejection/jetting zone is depicted by ‘J1’; and the stagnation zone is depicted by ‘S1’ in FIG. 20.

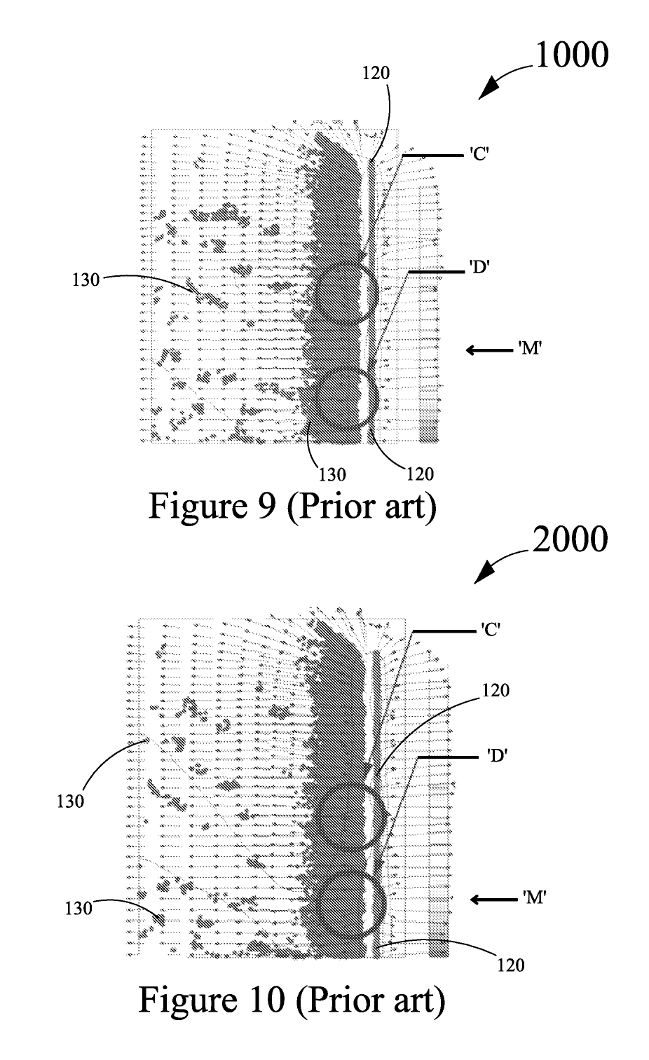

Using the aforementioned simulation, it was deduced that small particles have a strong tendency to follow the same trajectory as the large particles as depicted by a graph 7000 in FIG. 21 that illustrates a plan view of the print gap region 20 analogous to prior art to FIGS. 9-11. Specifically, the small particles are depicted by a plurality of particles 250 and large particles are depicted by a plurality of particles 260. FIG. 21 depicts the locations at which the particles 250 and 260 pass through a plane located a short distance above a boundary of the print medium 10. The particles 250 are grouped tightly with the particles 260 and are likely to arrive at the boundary of the print medium 10 in proximity to the particles 260.

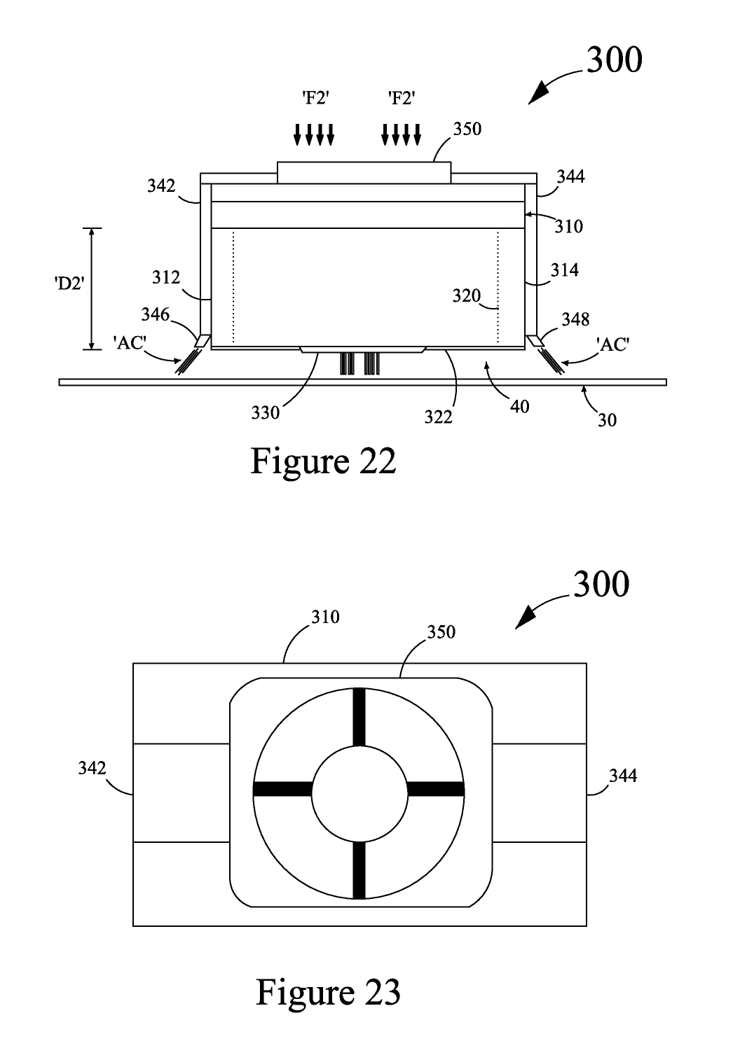

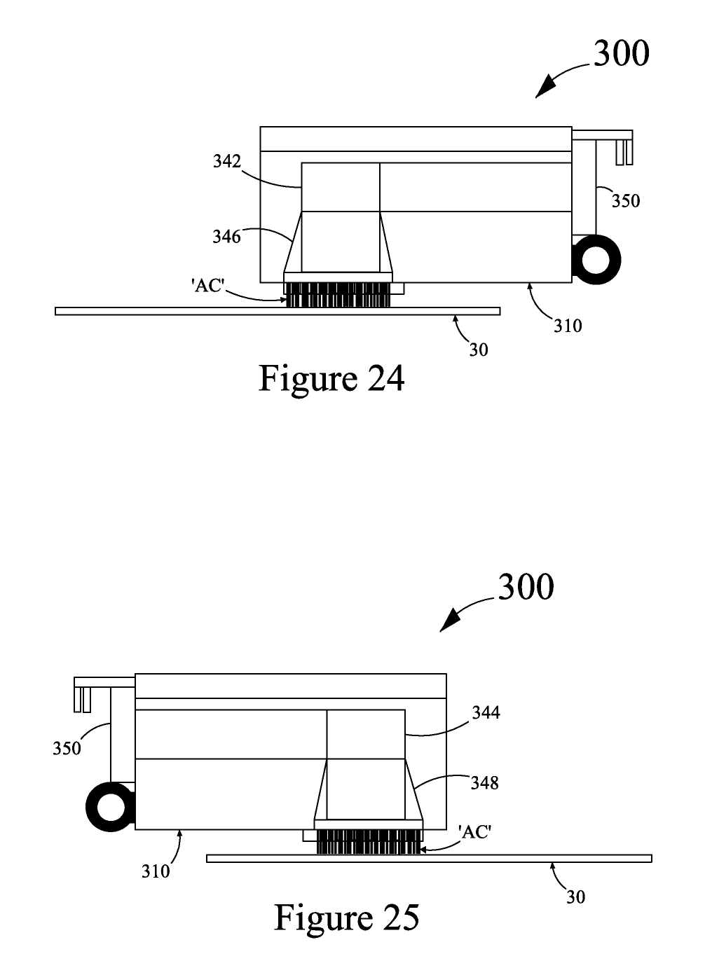

In another aspect and as depicted in FIGS. 22-25, the present disclosure further provides a system 300 for regulating airflow velocity in a print gap region of a micro-fluid ejection device, in accordance with another embodiment of the present disclosure. FIG. 22 depicts a front elevated view of the system 300. FIG. 23 depicts a top view of the system 300. FIGS. 24 and 25 depict partial left elevated and right elevated views of the system 300, respectively.

Referring to FIGS. 22-25, the system 300 includes a carrier member 310 configured to carry an ejection head 320 therewithin. The carrier member 310 is configured adjacent to a print medium 30 to define the print gap region 40 therebetween.

The system 300 also includes a nozzle array 330 configured on a bottom portion 322 of the ejection head 320. The nozzle array 330 is configured to eject a plurality of drops therefrom on the print medium 30 for printing.

Further, the system 300 includes a pair of channel members. The pair of channel members includes a first channel member 342 extending along a leading edge 312 of the carrier member and a second channel member 344 extending along a trailing edge 314 of the carrier member 310. Each of the first channel member 342 and the second channel member 344 further extends from a top portion (not numbered) of the carrier member 310 up to a bottom portion (not numbered) of the carrier member 310, and along a depth ‘D2’ of the carrier member 310. The each of the first channel member 342 and the second channel member 344 is configured to direct a flow of air (depicted as ‘F2’) from the top portion of the carrier member 310 towards the bottom portion of the carrier member 310, and into the print gap region 40 for forming an air curtain ‘AC’ within the print gap region 40 to regulate the airflow velocity in the print gap region 40.

Specifically, the each of the first channel member 342 and the second channel member 344 directs the flow of air at a pre-determined angle relative to a horizontal plane to (not shown) parallel to the nozzle array 330. The pre-determined angle ranges from about 25 degrees to about 80 degrees relative to the horizontal plane. Additionally, the each of the first channel member 342 and the second channel member 344 directs the flow of air at the pre-determined angle in a downward and outward direction away from the leading and trailing edges 312, 314 of the carrier member 310. Accordingly, the flow of air as directed by the first channel member 342 and the second channel member 344 in an outward direction serves as an outward blowing scheme at the leading and trailing edges 312 and 314 of the carrier member 310 that facilitates reduction of length of a settling zone (not shown) for a given speed of the carrier member 310. Reduction of the length of the settling zone assists in reducing the minimum distance between the nozzle array 330 and the leading edge 312 of the carrier member 310, and potentially the length needed for the turnaround of the ejection head 320 at each end of a print swath. The aforementioned effect could reduce the width of the micro-fluid ejection device by twice the reduction in the length of the settling zone.

The system 300 also includes a first vent 346 and a second vent 348 coupled to the first channel member 342 and the second channel member 344, respectively to facilitate the flow of air as directed from the first channel member 342 and the second channel member 344. Specifically, the first vent 346 and the second vent 348 blow air downward and outward at the predetermined angle away from the carrier member 310. Further, the first vent 346 and the second vent 348 are vents that extend from the respective first channel member 342 and the second channel member 344.

Furthermore, the flow of air is directed at a pre-determined velocity into the print gap region 40. The pre-determined velocity of the directed flow of air ranges from about one third in magnitude of velocity of the ejection head 320 to about four times in magnitude of the velocity of the ejection head 320.

As depicted in FIGS. 22-25, the system 300 also includes an air propelling member 350, such as a fan, coupled with the first channel member 342 and the second channel member 344 to provide the flow of air to the first channel member 342 and the second channel member 344.

Based on the foregoing, the system 300 provides a scheme to blow air down and away from the print gap region 40 in both upstream and downstream directions relative to the carrier member 310. Simulations of the geometry of the ejection head 320 with the to activation of the first channel member 342 and the second channel member 344; and the first vent 346 and the second vent 348, depict the modification of the flow velocity within the print gap region 40 such that the drops ejected from the nozzle array 330 experience much smaller cross-flow velocity as compared to the drops ejected by the ejection head 110 of the carrier member 100.

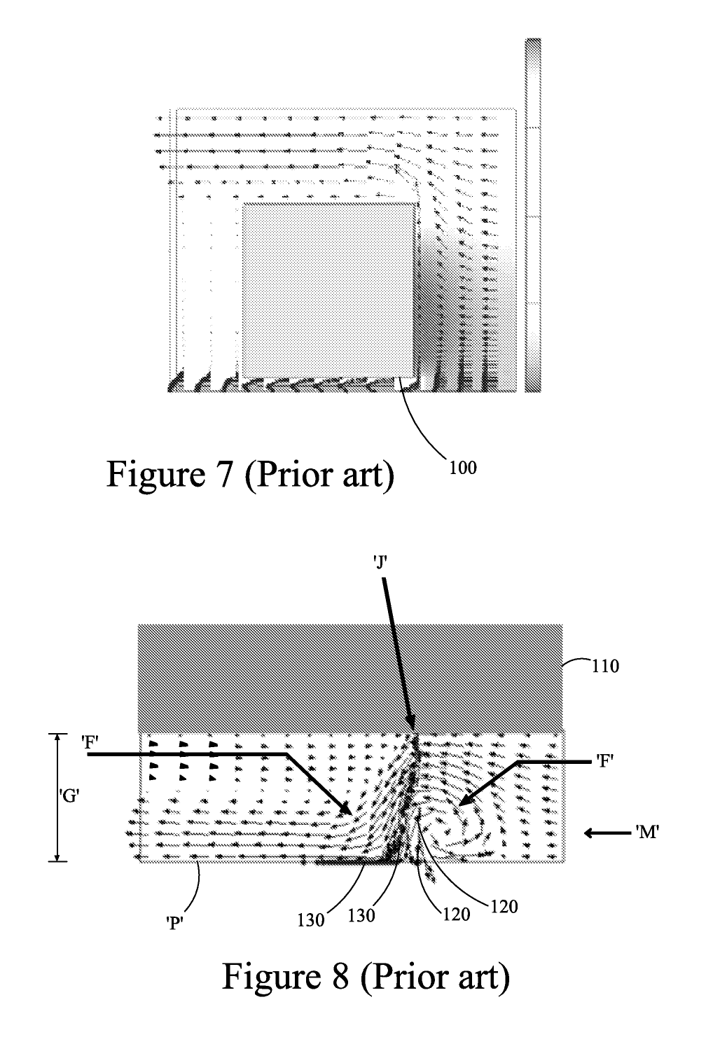

The simulations of the ejection head 320 used the same boundary conditions as depicted in FIG. 7. In the simulation for the ejection head 320, the first vent 346 and the second vent 348 eject air at about twice the scanning speed of the ejection head 320 from the leading edge 312 and the trailing edge 314 of the carrier member 310.

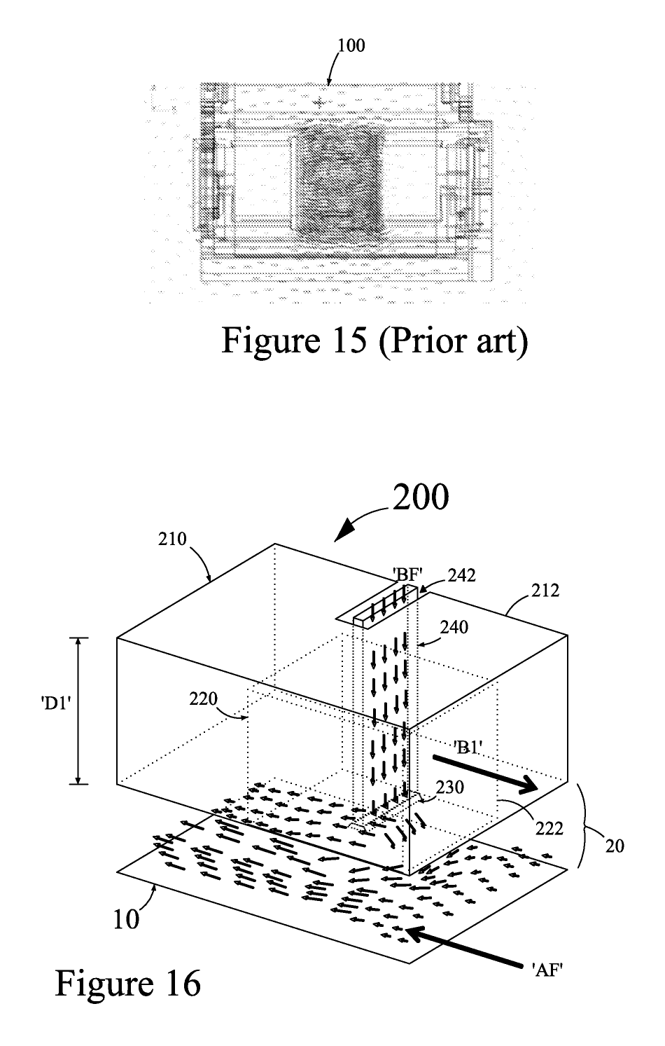

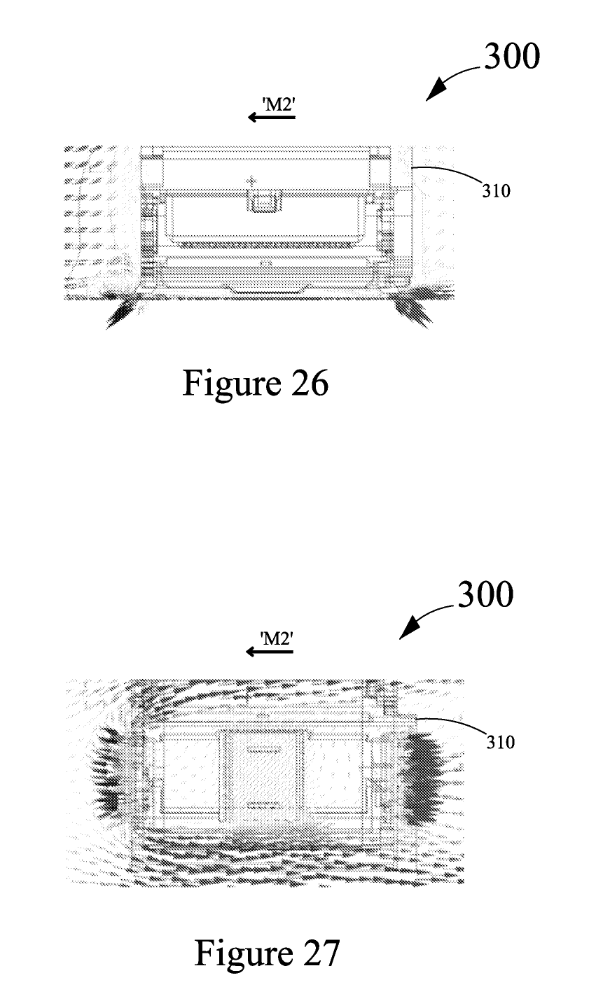

FIGS. 26 and 27 depict the airflow fields, i.e., velocity vectors, with the blowing scheme in comparison to FIGS. 14 and 15 that depict airflow fields, i.e., the velocity vectors, around the carrier member 100. Contrary to the carrier member 100 and the ejection head 110, the carrier member 310 and the ejection head 320 as depicted in FIGS. 26 and 27 are configured to move in a direction ‘M2’ and the oncoming flow of air appears to be a flow from an opposite direction.

Specifically, FIG. 26 depicts simulations of geometry of the ejection head 320, with the first channel member 342 and the second channel member 344 blowing the flow of air. More specifically, FIG. 26 depicts a representation of velocity vectors in a cross-section of airflow field around the carrier member 310 with the outward blowing scheme.

When compared with FIG. 14 that depicts velocity vectors in a cross-section of airflow fields around the carrier member 100 (conventional carrier member), it may be observed that the blowing scheme of FIG. 26 assists in modifying the flow velocity within the print gap region 40 such that the drops experience much smaller cross-flow velocity than the drops as ejected from the ejection head 110 of the carrier member 100. Accordingly, FIGS. 14 and 26 depict a comparison of the airflow fields around the ejection heads 110 and 320 in a vertical cross-section area/portion. The magnitude of the air velocity may be weighed in terms of the length of the velocity vectors in the scan direction, such as the direction ‘M2’. The air velocity in the scan direction in the print gap region 40 is to significantly reduced when the first vent 346 and the second vent 348 are activated. The maximum scan direction velocity without blowing (as depicted in FIG. 14) is about twice the scanning speed of the ejection head 110. Alternatively, the maximum scan direction velocity with the activation of the first vent 346 (leading vent) and the second vent 348 (trailing vent) is about half the scanning speed of the ejection head 320. Based on the foregoing, it may be observed that there exists a significant reduction in maximum scan direction air velocity due to the blowing scheme of the system 300.

FIG. 27 depicts a plan view illustrating the airflow fields around the carrier member 310 and the ejection head 320 in a horizontal cross-sectional portion located at the middle of the print gap region 40, in comparison to FIG. 15 that depicts the airflow fields around the carrier member 100 without implementing the blowing scheme. As depicted in FIG. 27, the oncoming air flows into the print gap region 40 and accelerates to a maximum velocity of about twice the scanning speed of the ejection head 320. When the first vent 346 and the second vent 348 are activated, the first vent 346 restricts oncoming air from flowing into the print gap region 40. The oncoming air is instead directed around the carrier member 310 far from the nozzle array 330. The directed stream of the oncoming air then reconnects at the trailing edge 314 of the carrier member 310 due to the second vent 348. The velocities within the print gap region 40 are about half the scanning speed of the ejection head 320, i.e., significantly lower than the velocities outside the footprint of the carrier member 310. Based on the foregoing, the system 300 demonstrates the strong positive effect of the blowing scheme on the airflow in the print gap region 40.

As depicted in FIGS. 26 and 27, the system 300 has the advantage that the airflow operates continuously and symmetrically with respect to the scan direction of the ejection head 320.

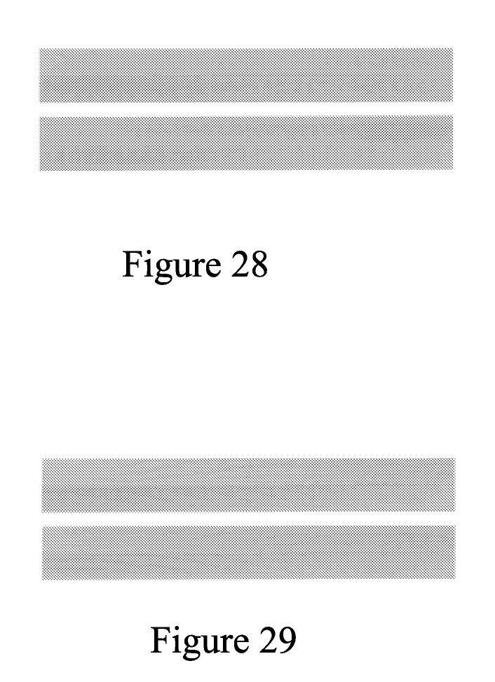

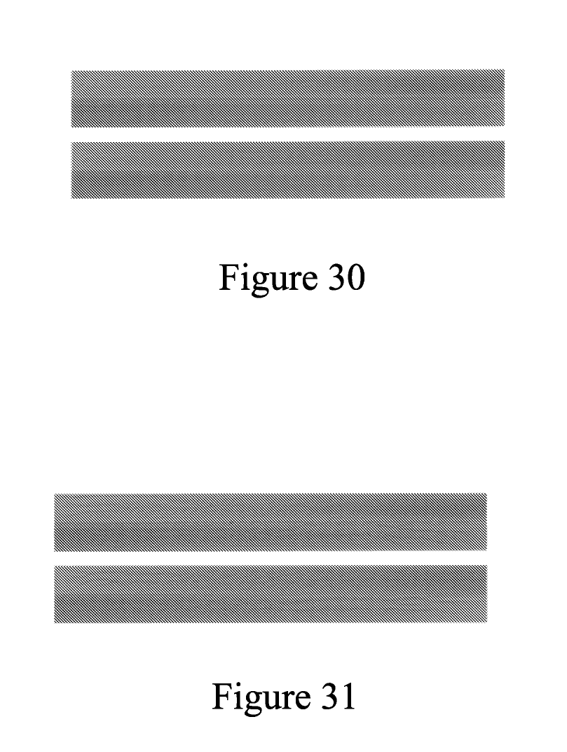

By employing the system 300, the wood grain print defect was significantly reduced in print samples produced by the ejection head 320. FIG. 28 depicts print samples at 9 kilo Hertz (kHz) produced by the ejection head 320 with the blowing scheme being implemented, as opposed to FIG. 29 that depicts print samples (with wood grain print defect) at 9 kHz without any implementation of the blowing scheme. Similarly, FIG. 30 depicts print samples at 18 kHz produced by the ejection head 320 with the blowing scheme to being implemented, as opposed to FIG. 31 that depicts print samples (with wood grain print defect) at 18 kHz without any implementation of the blowing scheme.

Based on the foregoing, the present disclosure provides systems 200 and 300 that assist in regulating, and more specifically, reducing the airflow velocity within a print gap region, such as the print gap regions 20 and 40.

As described above with respect to a conventional carrier member and ejection head, smallest satellite drops are most susceptible to drag forces in the print gap region due to respective small momentum; and interaction of downward jetting drop wakes with the oncoming air stream in the print gap region produces recirculation zones upstream and downstream of the nozzle/jetting arrays, and time-dependent and location-dependent horizontal velocity components that tend to alternately converge and diverge in the plan view as depicted in prior art FIGS. 9-11. The complex time-dependent flow field may deflect the smallest satellite drops to produce misting and the wood grain print defect. Non-uniform velocity profiles within the print gap region may also produce organized distortions of the drop trajectories that appear as noticeable print defects.

In contrast, the systems 200 and 300 assist in minimizing the cross-flow velocity experienced by the ejected/jetted drops within the print gap region, thereby facilitating the drops to reach respective destination on a print medium with minimal deflection by stream-wise drag forces. Specifically, the system 200 assists in blowing air into the print gap region at a downward angle behind the nozzle array 230 to create the stagnation zone relative to the ejection head 220 just at the point where nozzles are located. Further, the system 300 assists in blowing air in an outward and downward direction at the leading and trailing edges 312 and 314 of the carrier member 310. The blowing velocity and geometry are designed to minimize the mid-gap velocity relative to the ejection head 320.

The systems 200 and 300 may also assist in reducing fluid dry time due to increased convection downstream of a print zone. Further, the configuration of the nozzle array, and specifically, nozzles of the nozzle array, being located downstream of the settling zone assists in minimizing non-uniformity of the print gap velocity profile due to the leading edge vortex. Accordingly, the implementation of the systems 200 and 300 with the aforementioned configuration of the nozzles of the nozzle array may allow reduction in the width of the micro-fluid ejection devices employing the systems 200 and 300.

The foregoing description of several embodiments of the present disclosure has been presented for purposes of illustration. It is not intended to be exhaustive or to limit the disclosure to the precise forms disclosed, and obviously many modifications and variations are possible in light of the above teaching. It is intended that the scope of the disclosure be defined by the claims appended hereto.

What is claimed:

1. A system for regulating airflow velocity in a print gap region of a micro-fluid ejection device, the system comprising:
a carrier member configured to carry an ejection head therewithin, the carrier member configured adjacent to a print medium during use to define the print gap region therebetween;
a nozzle array configured at a bottom portion of the ejection head, the nozzle array configured to eject a plurality of drops therefrom on the print medium for printing; and
a channel member extending from a top portion of the carrier member and along a depth of the carrier member up to the bottom portion of the ejection head, the channel member further extending along at least a width of the nozzle array, the channel member configured to receive a flow of air through a slot configured at the top portion of the carrier member, the channel member further configured to direct the flow of air from the top portion of the carrier member towards the bottom portion of the ejection head and into the print gap region for creating a stagnation zone under the nozzle array, the stagnation zone extending up to a depth of the print gap region to regulate the airflow velocity in the print gap region.

2. The system of claim 1, wherein the channel member directs the flow of air from the top portion of the carrier member towards the bottom portion of the ejection head and into the print gap region in synchronization with ejection of the plurality of drops from the nozzle array in order to regulate the airflow velocity in the print gap region.

3. The system of claim 1, wherein the channel member directs the flow of air from the top portion of the carrier member towards the bottom portion of the ejection head and into the print gap region relative to the movement of the ejection head and the print medium.

4. The system of claim 1, wherein the channel member directs the flow of air at a pre-determined angle relative to a horizontal plane parallel to the nozzle array for creating the stagnation zone, the flow of air further being directed at a pre-determined velocity.

5. The system of claim 4, wherein the pre-determined angle relative to the horizontal plane ranges from about 25 degrees to about 80 degrees.

6. The system of claim 4, wherein the pre-determined velocity of the directed flow of air ranges from about one third in magnitude of velocity of the ejection head to about four times in magnitude of the velocity of the ejection head.

7. The system of claim 1, wherein the channel member directs the flow of air from the top portion of the carrier member towards the bottom portion of the ejection head and into the print gap region from behind the nozzle array.

8. The system of claim 1, wherein the nozzle array is configured adjacent to a portion of the print gap region, the portion defining a zone of uniform gradient of velocity of the airflow, wherein the uniform gradient of velocity is experienced by the plurality of drops.

9. The system of claim 1, wherein the channel member is configured orthogonal to the print medium.

10. The system of claim 1, wherein the flow of air is blown into the channel member by an air propelling member.

11. A system for regulating airflow velocity in a print gap region of a micro-fluid ejection device, the system comprising:
a carrier member configured to carry an ejection head therewithin, the carrier member configured adjacent to a print medium to define the print gap region therebetween;
a nozzle array configured at a bottom portion of the ejection head, the nozzle array configured to eject a plurality of drops therefrom on the print medium for printing; and
a pair of channel members, the pair of channel members comprising a first channel member extending along a leading edge of the carrier member and a second channel member extending along a trailing edge of the carrier member, each of the first channel member and the second channel member further extending from a top portion of the carrier member up to a bottom portion of the carrier member and along a depth of the carrier member, wherein the each of the first channel member and the second channel member is configured to direct a flow of air from the top portion of the carrier member towards the bottom portion of the carrier member and into the print gap region for forming an air curtain within the print gap region to regulate the airflow velocity in the print gap region.

12. The system of claim 11, wherein the each of the first channel member and the second channel member directs the flow of air at a pre-determined angle relative to a horizontal plane parallel to the nozzle array, the flow of air further being directed at a pre-determined velocity into the print gap region.

13. The system of claim 12, wherein the each of the first channel member and the second channel member directs the flow of air at the pre-determined angle in a downward and outward direction away from the leading and trailing edges of the carrier member.

14. The system of claim 12, wherein the pre-determined angle ranges from about 25 degrees to about 80 degrees.

15. The system of claim 12, wherein the pre-determined velocity of the directed flow of air ranges from about one third in magnitude of velocity of the ejection head to about four times in magnitude of the velocity of the ejection head.

16. The system of claim 11, further comprising a pair of vents, the pair of vents comprising a first vent extending from the first channel member and a second vent extending from the second channel member, the first vent and the second vent configured to facilitate the flow of air to be directed from the top portion of the carrier member towards the bottom portion of the carrier member and into the print gap region.

17. The system of claim 11, further comprising an air propelling member coupled with the first channel member and the second channel member to provide the flow of air to the first channel member and the second channel member.
